(19) United States
(12) Patent Application Publication
(10) Pub. No.: US 2006/0045014 A1
(43) Pub. Date: Mar. 2, 2006

(54) Method for partially maintaining packet sequences in connectionless packet switching with alternative routing

(75) Inventor: Joachim Charzinski, Munchen (DE)

Correspondence Address: Siemens Corporation;Intellectual Property Department, 170 Wood Avenue South, Iselin, NJ, 08830, US

(73) Assignee: Siemens Aktiengesellschaft, Muenchen (DE)

(21) Appl. No.: 10/529,779

(22) PCT Filed: Sep. 29, 2003
(86) PCT No.: PCT/DE03/03246

§ 371 Date: Mar. 30, 2005

(30) Foreign Application Priority Data
Sep. 30, 2002 (DE) 102 45 490.6

(51) Int. Cl. H04J 1/16

(52) U.S. Cl. 370/235; 370/412

(57) ABSTRACT

In order improve maintenance of packet sequences in a connectionless network comprising several routers enabling the packets of a flow to be transmitted via several pathways, a packet arriving in a router is transmitted on a route in the same way as a packet which is already located in the router and belongs to the same flow or an incoming packet in the router, which arrives in the router within a time window and which is opened by a packet belonging to the same flow, is transmitted on the same route as the packet opening said window.

The application relates to a method for maintaining the sequence of packets in connectionless packet switching with alternative routing for a network comprising a plurality of routers.

Networks with connectionless packet switching (e.g. the present-day Internet) generally have no facility for maintaining the sequence of packets during transportation through the network, i.e. for providing the same sequence at the output from the network as at the input, if the route to a destination within the network can be individually selected for each packet, for example, in order to distribute the load.

Errors in the packet sequence can, for example, reduce the throughput of connections unnecessarily where said throughput is regulated by the TCP protocol (Transmission Control Protocol).

In order not to overload the network and to achieve a fair division of the overall bit rate among a large number of connections, a TCP transmitter adjusts its transmission rate downward (by reducing the transmit window) after a packet loss has been detected. Also, a packet sequence transposed in the network leads in practice to repeated confirmations with the same sequence number, so TCP also reduces the rate here.

For the aforementioned reasons, alternative routing at packet level, i.e. distribution of packet traffic in a flow, is not generally used today. In order to avoid the aforementioned problems, alternative routing at the level of (aggregated) flows is proposed, for example in MPLS (multi-protocol label switching), i.e. all packets which belong to the same connection or which are exchanged between the same pair of network nodes, are sent on the same path through the network. For this to occur, however, appropriate network information has to be filed in each network node, e.g. by configuring paths (static) or by first establishing a path for each connection (dynamic but time-consuming and therefore not necessarily scaleable for large networks). The number of flows to be stored depends here very heavily on the duration of the flows and may, in the case of long flows each containing little traffic, be very large.

Furthermore, equipment which restores the packet sequence can be used at the network output. In IP (Internet Protocol) networks, however, this is no mean task, since IP packets generally possess no sequence number for such purposes. While the “Identity” field in the packet header identifies a packet uniquely, it is not necessarily increased by 1 in each case within each TCP connection or each UDP (User datagram protocol) association. In order to evaluate the TCP “sequence number” specified on the octet level, the packet header has to be further evaluated, as this number increases from one TCP segment to the next by the number of bytes in the segment. Since the segments can also carry different quantities of user information within a connection, a resequencing device cannot know how many packets are still missing between two other packets which have been received if the sequence numbers thereof do not follow one another. In addition, if a resequencing device were used, packet losses would cause a delay in the playing out of the packets and thus cancel out the “fast retransit” mechanism of TCP, which would cause the bandwidth control in TCP to be adjusted sharply downward and would thus bring no advantage compared with delivery out of sequence.

The object of the invention is to specify a method which in a network comprising multiple routing options reduces performance degradation caused by packet overhauls.

This object is achieved in the features of claim 1 or of claim 4.

The invention sharply reduces the frequency of packet overhauls, in particular for high-bit-rate connections. The frequency of transpositions in the packet sequence is reduced by means of the aforementioned technical features. The maximum number of flow entries in the flow table FT is predetermined by the number of packets to be stored in the router. The restriction to packets stored in the router thus sharply reduces the quantity of status information in the router compared with solutions like MPLS or IP switching, which have to maintain a status for each existing flow. In addition, in contrast to MPLS or IP switching, no signaling is needed between the network nodes so that, particularly in the case of short flows, no unnecessary delay occurs. Restricting status information to a short service life also has the advantage that the flexibility of alternative routing for distributing the load in the network remains assured, so a compromise can be reached between absolute adherence to the packet sequence and optimum load distribution. Connections which transmit at a high rate and of which there is always at least one packet stored temporarily in the router, will experience no sequence transpositions. Connections in which a packet is transmitted only rarely, will also have no problems if the runtime differences between the different paths selected in the network are small in comparison to the time between two packets. The solution described is therefore advantageous in particular for connections in which data is transmitted in bursts (e.g. World Wide Web).

Advantageous further developments of the invention are specified in the subclaims.

The invention will be explained in detail below as an exemplary embodiment to an extent necessary for comprehension with reference to the drawings, in which

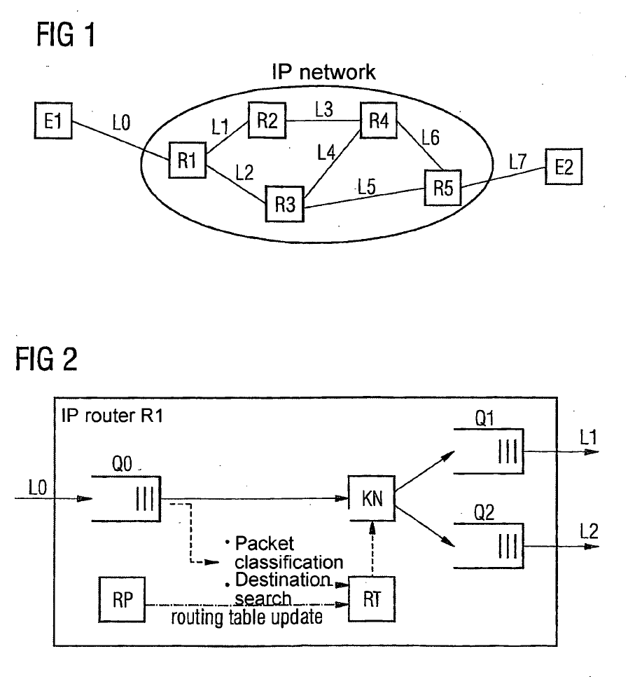

FIG. 1 shows a simplified representation of an IP network,

FIG. 2 shows a schematic representation of an IP router,

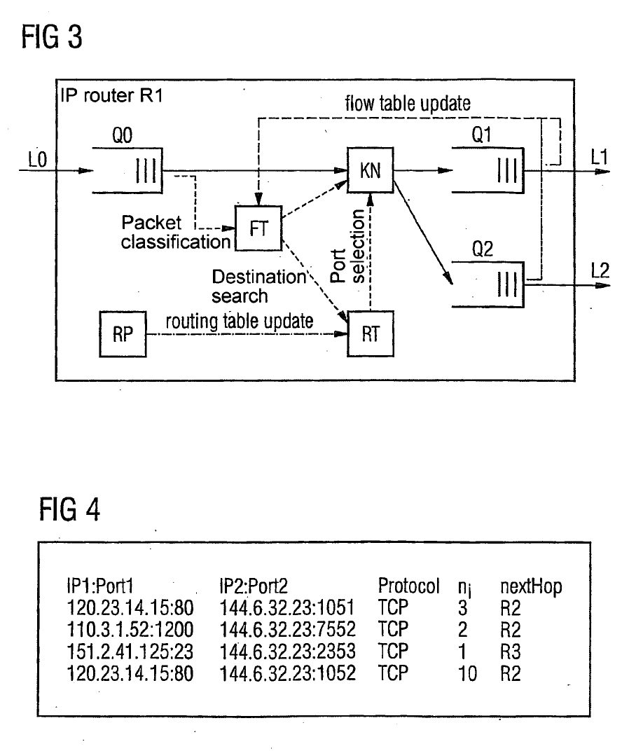

FIG. 3 shows a schematic representation of an IP router according to the invention and

FIG. 4 shows a schematic representation of the content of the flow table FT.

In the figures, the same reference characteristics indicate the same elements.

FIG. 1 shows a simple network in which two terminal devices E1 and E2 are connected to one another via a plurality of paths, the routers R1 to R5 being designed to perform connectionless packet switching between the links (lines) L0, L1, L2, . . . L7. FIG. 2 shows a part of the IP router R1, as constructed according to the prior art, for a direction of transmission (from L0 to L1 and L2). When a packet arrives, it is classified, the destination IP address is read out and the next router on the path to the destination is determined for this address from the routing table RT. The routing table receives current routing information from the routing protocol processor RP which exchanges accessibility information with other routers via a routing protocol. As a rule, the shortest path, that is the shortest path to the destination (according to a predeterminable metric) is entered as the only path in the routing table RT.

In the case of the load being distributed to a plurality of alternative routes, the routing table is extended and contains, in addition to the next node on the shortest path, further next nodes for further permissible paths to the destination. For each arriving packet a permissible output path to the destination, to which path the packet is then forwarded, can now be chosen on the basis of a load distribution algorithm.

It is proposed according to the invention that a table of flow or connection information (referred to below only as flow information FI) be maintained in the router, which table stores the selected route for each packet which is located in the router (that is, which is temporarily stored in one of the queues Q1, Q2 or Q3 or which has just been switched in the switching network). If (in this embodiment) the packet leaves the router, then the information is deleted again. If a new packet with the same FI comes to the router, then it is forwarded on the same path as the last packet with the same FI.

The decision as to which of the alternative paths a packet will be forwarded on is therefore retaken only if no packet with the same FI as a newly arrived packet is already located in the router. The frequency of packet overhauls for high-bit-rate connections is greatly reduced by this means.

The appropriate router in FIG. 3 contains in addition to the components of the router from FIG. 2 a flow table FT in which the selected next hop is filed for all packets which are still located in the router and already classified. A check is carried out for each newly arriving packet to ascertain whether it belongs to one of the flows in the FT. If a packet of the corresponding flow is recorded in the FT, the same next hop is also selected for the new packet. If no packet of the same flow is recorded in the FT, a next hop is selected for this packet using the rules of alternative routing and load distribution, the packet is forwarded in the direction of this next node and the flow information together with the selected next hop stored in the FT. FIG. 4 shows by way of example what such an FT might look like. The FT contains for each flow i, packets of which are located in an output queue of the router, the number ni of packets in the queues, the flow characteristic information (source IP, destination IP, source port, destination port, protocol) and the next hop chosen for this flow. The packet counter for each flow is increased by 1 with each packet arriving for this flow and decreased by 1 with each packet leaving the router for this flow. If the counter reaches the value 0, the entry is deleted from the table.

### FURTHER EMBODIMENTS

1. The principle can be applied to each queue individually, to a subset or to all buffers in a device, if an IP router uses for example input and output buffers or a combination of such buffers with a central buffer. The following alternatives are possible:
a) separate FT and separate packet counting. In this case, the FT relates only to the queue at the output of which the decision on forwarding to a defined path will be taken. Any output buffers located behind this and the packets contained therein will have no further influence on the route decided for new packets.
b) shared FT and separate packet counting. The FT contains in this case a packet counter for each queue, said packet counter being updated in each case upon arrival and departure of a packet in/from the queue. The forwarding decision is stored for each flow.
c) shared FT and shared packet counting. The FT is structured according to FIG. 4, whereby ni refers to the sum of all packets of the flow i in all queues examined. The forwarding decision is also influenced here by the packets of a flow which have already passed the decision point. This option b)/c) is preferable to a).

2. IP routers generally have an output queue for each output link, whereby the output link can be a physical network connection or a logic channel within a physical connection (e.g. an ATM-VP (Asynchronous Transfer Mode-Virtual Path) or ATM-VC (Asynchronous Transfer Mode-Virtual Channel), a wavelength or an STM (Synchronous Transport Module) channel). In backbone routers, just one IP router is generally assigned to each of these channels. In local area networks, by contrast, one output channel can reach a plurality of next IP routers if the channel is e.g. a shared medium (Ethernet or similar). In this case, there are the options of entering either the output channel or—as indicated in FIG. 4—the “next hop” for a flow in the flow table FT. The latter option appears more useful; for other reasons (e.g. internal structure of the router) it may, however, be necessary to enter the output channel as a substitute for the “next hop”.

3. In the description relating to FIG. 3, it is provided for flows to be removed from the flow table as soon as no more corresponding packets are located in the router. Alternatively, an ageing-out can also be provided in which instead of the number ni of packets of a flow a time stamp for the last packet arrival is stored in the flow table FT in FIG. 4. The entries are then periodically or after the expiration of a time limit after arrival removed from the table, if the time at which the last packet of a flow was observed already lies in the past by at least a predeterminable period.

4. If a router handles a plurality of traffic classes, the method can be used for all or for only a portion of the traffic classes.

5. A time limit according to option 3 can be adjusted adaptively according to other parameters. Parameters which may be considered here are in particular those which determine the distribution of traffic (e.g. the frequency for the choice of an alternative path).

1-7. (canceled)

8. A method for maintaining a sequence of packets in a connectionless packet switching network including an alternative routing in the network, comprising:
providing a packet flow having at least a first packet and a second packet;
receiving the first packet by a router and selecting a route for the first packet;
storing the selected route in the router;
forwarding the first packet along the selected route;
receiving the second packet by a router and forwarding the second packet along the stored route;
determining a remaining number of packets belonging to the packet flow; and
deleting the selected route if the remaining number of packets is zero.

9. The method according to claim 8, wherein the remaining number of packets is based on the packets belonging to the packet flow that are remaining in the router.

10. The method according to claim 8, wherein the remaining number of packets is based on the packets belonging to the packet flow that are remaining in a queue within the router.

11. The method according to claim 8, wherein the remaining number of packets is based on the packets belonging to the packet flow that are remaining in a plurality of queues within the router.

12. A method for maintaining a sequence of packets in a connectionless packet switching network including an alternative routing in the network, comprising:
storing a receive time of a first packet received by a router as a packet flow time;
selecting a route for the first packet;
storing the selected route based on a packet flow of the first packet;
forwarding the first packet to the selected route;
receiving a second packet belonging to the packet flow by the router;
updating the packet flow time with a receive time of the second packet;
forwarding the second packet to the stored route; and
deleting the stored route and the stored packet flow time after a time from receiving a last packet in the packet flow.

13. The method according to claim 12, wherein the stored route and stored packet flow time are deleted.

14. The method according to claim 12, wherein the time is based on a distribution of a traffic.

15. A router for maintaining a sequence of packets in a connectionless packet switching network including an alternative routing, comprising:
a flow table for storing and retrieving a route for a packet in a packet flow;
a first element for determining if the route is stored in the flow table for the packet, if the route is not stored a second element selects a packet flow route for the packet and subsequently stores the packet flow route in the flow table; and
a sender for sending packets along the stored route.

16. The router according to claim 15, wherein the stored route in the flow table is deleted when the packet does not exist in the router.

17. The router according to claim 15, wherein the router comprises a plurality of flow tables wherein each flow table relates to a queue in the router.

18. The router according to claim 17, wherein the stored route in the flow table is deleted when the packet does not exist in the queue related to the table.

19. The router according to claim 15, further comprising a storage unit for storing and retrieving the arrival time of the last packet in the packet flow, the arrival time for aging the stored route.

20. The router according to claim 19, wherein the aging is based on a time limit after the arrival of the last packet in the flow.
